(19) United States
(12) Patent Application Publication
(10) Pub. No.: US 2026/0349724 A1
(43) Pub. Date: Nov. 5, 2026

(54) METHOD, APPARATUS, AND SYSTEM FOR EXECUTING INSTRUCTION, AND SERVER

(71) Applicant: ZTE CORPORATION, Shenzhen, Guangdong (CN)

(72) Inventors: Shuzhou DAI, Shenzhen, Guangdong (CN); Zhijia LIAO, Shenzhen, Guangdong (CN); Feng YU, Shenzhen, Guangdong (CN); Lin YAN, Shenzhen, Guangdong (CN); Xin CHENG, Shenzhen, Guangdong (CN); Qiangjun LIU, Shenzhen, Guangdong (CN); Jun WANG, Shenzhen, Guangdong (CN); Cheng GUO, Shenzhen, Guangdong (CN)

(21) Appl. No.: 19/105,120

(22) PCT Filed: Aug. 21, 2023
(86) PCT No.: PCT/CN2023/114014

§ 371 Date: Feb. 20, 2025

(30) Foreign Application Priority Data
Aug. 26, 2022 (CN) 202211037817.7

(51) Int. Cl. G06F 9/30

(52) U.S. Cl. CPC G06F 9/30043

(57) ABSTRACT

A method, apparatus, and system for executing an instruction. The method includes: acquiring (S110) an instruction acquisition request in a target queue, the instruction acquisition request being used for instructing to acquire a target instruction; determining (S120), based on the instruction acquisition request, an instruction acquisition address corresponding to the target queue according to a preset mapping relationship, the mapping relationship indicating a correspondence between information of a queue where the target queue is located and the instruction acquisition address; acquiring (S130) the target instruction according to the instruction acquisition address; and executing (S140) an operation corresponding to the target instruction according to the target instruction.

### CROSS-REFERENCE TO RELATED APPLICATIONS

The present disclosure claims priority to Chinese Patent Application No. 202211037817.7, filed on Aug. 26, 2022, the entire content of which is incorporated herein by reference.

### TECHNICAL FIELD

The present disclosure belongs to the technical field of storage and particularly relates to a method, apparatus, and system for executing an instruction, and a server.

### BACKGROUND

At present, with development of a virtualization technology, a plurality of virtualized storage devices may be constructed and presented between a host and a user through peripheral component interconnect express (PCIE, a high-speed serial computer expansion bus standard), these virtualized storage devices implement releasing of resources of a CPU of the host in an unloading mode. The virtual devices in the field of storage are primarily non volatile memory host controller interface (NVME) devices at present, and each NVME device needs to occupy a corresponding hardware resource (namely, a storage resource).

Each NVME device is bound to a corresponding NVME controller, storage interaction is performed between each NVME device and the NVME controller thereof through a plurality of queues, and the plurality of NVME devices correspond to a large quantity of NVME queues. In a standard NVME protocol, a submission queue (SQ) and a completion queue (CQ) are carriers of an NVME storage command and are used for carrying a specific command and a command completion state of interaction between a host and the NVME device. Each SQ and a CQ corresponding thereto may be called a queue pair (QP).

### SUMMARY

In a first aspect, an embodiment of the present disclosure provides a method for executing an instruction. The method is applied to a virtual device. The method includes: acquiring an instruction acquisition request in a target queue, the instruction acquisition request being used for instructing to acquire a target instruction; determining, based on the instruction acquisition request, an instruction acquisition address corresponding to the target queue according to a preset mapping relationship, the mapping relationship indicating a correspondence between information of a queue where the target queue is located and the instruction acquisition address; acquiring the target instruction according to the instruction acquisition address; and executing an operation corresponding to the target instruction according to the target instruction.

In a second aspect, an embodiment of the present disclosure provides a method for executing an instruction. The method is applied to a server. The method includes: sending an instruction acquisition request to a target queue of a virtual device, the instruction acquisition request being used for instructing to acquire a target instruction so that the virtual device acquires the target instruction based on a preset mapping relationship, and the mapping relationship indicating a correspondence between information of a queue where the target queue is located and the instruction acquisition address.

In a third aspect, an embodiment of the present disclosure provides an apparatus for executing an instruction. The apparatus includes: a request acquiring unit, configured to acquire an instruction acquisition request in a target queue, the instruction acquisition request being used for instructing to acquire a target instruction; an address determining unit, configured to, based on the instruction acquisition request, determine an instruction acquisition address corresponding to the target queue according to a preset mapping relationship, the mapping relationship indicating a correspondence between information of a queue where the target queue is located and the instruction acquisition address; an instruction acquiring unit, configured to acquire the target instruction according to the instruction acquisition address; and an instruction executing unit, configured to execute an operation corresponding to the target instruction according to the target instruction.

In a fourth aspect, an embodiment of the present disclosure provides a server. The server includes: a request sending unit, configured to send an instruction acquisition request to a target queue of a virtual device, the instruction acquisition request being used for instructing to acquire a target instruction so that the virtual device acquires the target instruction based on a preset mapping relationship, and the mapping relationship indicating a correspondence between information of a queue where the target queue is located and the instruction acquisition address.

In a fifth aspect, an embodiment of the present disclosure provides a system for executing an instruction. The system includes the above server and at least one virtual device, wherein the at least one virtual device includes the above apparatus for executing the instruction.

In a sixth aspect, an embodiment of the present disclosure provides an electronic device. The electronic device includes a processor and a memory, the memory stores a program or an instruction capable of being run on the processor, and the program or the instruction, when run by the processor, performs steps of the method in the first aspect or the second aspect.

In a seventh aspect, an embodiment of the present disclosure provides a readable storage medium. The readable storage medium stores a program or an instruction, and the program or the instruction, when run by a processor, performs steps of the method in the first aspect or the second aspect.

### BRIEF DESCRIPTION OF DRAWING(S)

FIG. 1 is a schematic flowchart of a method for executing an instruction according to some embodiments.

FIG. 2 is another schematic flowchart of a method for executing an instruction according to some embodiments.

FIG. 3 is another schematic flowchart of a method for executing an instruction according to some embodiments.

FIG. 4 is yet another schematic flowchart of a method for executing an instruction according to some embodiments.

FIG. 5 is a structural block diagram of a system for executing an instruction according to some embodiments.

FIG. 6 is a structural block diagram of an apparatus for executing an instruction according to some embodiments.

FIG. 7 is a structural block diagram of a server according to some embodiments.

FIG. 8 is a diagram of a working principle of a system for executing an instruction according to some embodiments.

FIG. 9 is a diagram of a working principle of a user storage control system according to some embodiments.

FIG. 10 is a schematic structural diagram of an electronic device according to some embodiments.

### DETAILED DESCRIPTION

In order to make those skilled in the art better understand technical solutions of embodiments of the present disclosure, the technical solutions in the embodiments of the present disclosure are described clearly below with reference to the accompanying drawings in the embodiments of the present disclosure, and apparently, the described embodiments are some embodiments but not all embodiments of the present disclosure. Based on the embodiments of the present disclosure, all other embodiments obtained by those of ordinary skill in the art should fall within the protection scope of the present disclosure.

It needs to be noted that in the present disclosure, “for example” and the like are used for representing an example, an example illustration or an explanation. Any embodiment or design solution described “for example” in the present disclosure is not supposed to be construed as being more preferable or more superior than other embodiments or design solutions. Rather, “for example” and the like are used for the purpose of presenting a related concept in a detailed manner.

In the related art, an NVME device has a multiqueue characteristic, namely, a plurality of channels can be constructed between a host and the NVME device so as to perform command transmission and data interaction, and carriers corresponding to these channels are queues. Existence of queues of a plurality of NVME devices enables the host to perform submission of commands and processing of command completion results in parallel by using a plurality of cores or threads.

As demands of different NVME devices for the queues according to their own services may be different, moreover, with development of cloud storage services, there are increasing demands of users for the quantity of NVME devices, and each NVME device needs a certain queue resource for implementing its service and function. How to effectively manage the plurality of NVME devices under a limited hardware condition to complete various storage service demands is a problem urgent to be solved at present.

Given that in the related art, the plurality of NVME devices cannot be effectively managed under the limited hardware resource (namely, the storage resource) and thus the various storage service demands can not be completed well, an embodiment of the present disclosure provides a solution for executing an instruction, and the solution implements a dynamic management for storage resources of queues of virtual devices by setting a mapping relationship between the queues of the virtual devices and the queue storage resources, so that the plurality of virtual devices may be effectively managed under the limited storage resource, and the various storage service demands may be implemented well.

It needs to be noted that the solution for executing the instruction in the embodiment of the present disclosure may be applied to a virtual device in the field of storage, and in the embodiment of the present disclosure, the virtual device is described in detail by taking the NVME device as an example.

The solution for executing the instruction provided by the embodiment of the present disclosure is described in detail below through an example and an application scenario thereof with reference to accompanying drawings.

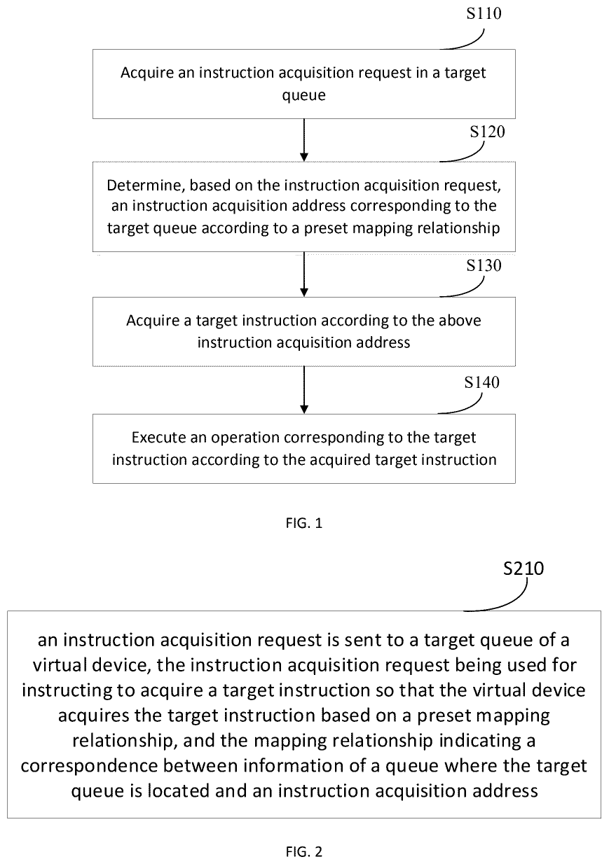

FIG. 1 is a schematic flowchart of a method for executing an instruction according to some embodiments. As shown in FIG. 1, the method may include S110 to S140 as follows.

S110: an instruction acquisition request in a target queue is acquired, the instruction acquisition request being used for instructing to acquire a target instruction.

In the embodiment of the present disclosure, a queue implements instruction transmission between an NVME device and a server (corresponding to the above host), and the queue may be called a queue QP. The instruction here may be a storage service instruction, and the instruction acquisition request is used for instructing to acquire the target instruction from the server.

Before S110 is performed, at least one queue is built according to a service demand. Generally speaking, a plurality of queues need to be built for implementing various storage service demands. Afterwards, a storage space (namely, a hardware resource, or called a storage resource) may be divided into sub-storage-spaces which have the same quantity as the quantity of built queues, and the sub-storage-spaces are respectively distributed to corresponding queues.

The storage space here may be a storage space corresponding to the server. During an actual operation, the storage space may be a storage space of the server, or may also be a plug-in storage space corresponding to the server. The storage space may store the target instruction, or may also store other information.

The sub-storage-spaces here are at least used for storing the instruction acquisition address and an instruction result storage address. The instruction acquisition address refers to an address for storing an instruction, which may be called an SQ base address. The instruction result storage address refers to an address for storing an instruction result, which may be called a CQ base address.

For example, 128 queues are built according to service demands, the storage space needs to be divided into 128 sub-storage-spaces, and the sub-storage-spaces are respectively distributed to the corresponding queues. Accordingly, through the sub-storage-spaces, the queues may perform data transmission with the server.

For convenience of description, the storage space for the queues is uniformly called the storage resource below, the sub-storage-space is uniformly called a sub-resource, and the server is uniformly called the host.

In the embodiment of the present disclosure, the storage resource may be divided into a plurality of sub-resources in an equipartition manner, or may also be divided into sub-resources according to actual situations, which is not limited by the present disclosure. For convenience of the description, the embodiment of the present disclosure is described in detail by taking a resource equipartition manner as an example.

S120: based on the instruction acquisition request, an instruction acquisition address corresponding to the target queue is determined according to a preset mapping relationship, the mapping relationship indicating a correspondence between information of a queue where the target queue is located and the instruction acquisition address.

In some embodiments, the mapping relationship may be set in the following manner: after a sub-resource to which a queue belongs is distributed to each queue, a correspondence between the information of the queue and information of the sub-resource to which the queue belongs may be acquired, and the mapping relationship is set according to the acquired correspondence.

In an embodiment, the information of the queue and the sub-resources may be numbered respectively, and the correspondence is represented in a numbering manner. For example, a queue 3 corresponds to a resource number 32, which represents that in a plurality of queues of the plurality of virtual devices, the resource number 32 is a resource special for the queue 3, and a sub-resource corresponding to the number 32 may implement an instruction transmission between the queue 3 and the host.

In some embodiments, the mapping relationship may also indicate a correspondence among information of a queue (for example, a queue number), a virtual device to which the queue belongs, information of the sub-resource to which the queue belongs (for example, a resource number).

In an embodiment, the information of the queue, the virtual devices and the resources may be numbered respectively, and the correspondence is represented in a numbering manner. For example, the queue 3 of a virtual device 5 corresponds the resource number 32, which represents that in the plurality of virtual devices, the resource number 32 is a storage resource special for the queue 3 of the virtual device 5, and the storage resource corresponding to the number 32 may be used for implementing instruction transmission between the queue 3 of the virtual device 5 and the host.

S130: the target instruction is acquired according to the above instruction acquisition instruction.

S140: an operation corresponding to the target instruction is executed according to the acquired target instruction.

After executing the operation according to the target instruction is completed, an executing result of the target instruction may be sent to a storage space corresponding to an instruction result storage address in a sub-storage-space.

In other words, the instruction result storage address in the sub-storage-space indicates a detailed storage position for storing an instruction result.

In the embodiment of the present disclosure, after the instruction acquisition request of the target queue is acquired, the instruction acquisition address corresponding to the target queue is determined according to the mapping relationship, the target instruction is acquired according to the instruction acquisition address, and the target instruction is executed. In this way, through the preset mapping relationship, the queues and the resources to which the queues belong may be managed effectively, effective management of the virtual devices under the limited storage resource may be implemented, a storage service instruction may be better executed, and demands of various storage services are met.

In some embodiments, when a queue is deleted, a sub-resource of the queue is released. Accordingly, the released storage resource may be still used for a subsequently built new queue, effective management of the limited storage resource is further implemented, and a resource utilization ratio is improved.

Based on the similar inventive concept, an embodiment of the present disclosure further provides a method for executing an instruction, and the method is applied to a server (corresponding to the above host).

FIG. 2 is a flowchart of a method for executing an instruction applied to a server. As shown in FIG. 2, the method includes S210.

S210: an instruction acquisition request is sent to a target queue of a virtual device, the instruction acquisition request being used for instructing to acquire a target instruction so that the virtual device acquires the target instruction based on a preset mapping relationship, and the mapping relationship indicating a correspondence between information of a queue where the target queue is located and an instruction acquisition address.

In an embodiment, the above mapping relationship further indicates a correspondence between the information of the queue where the target queue is located and the instruction result storage address. The method further includes: receiving an executing result of the target instruction from the target queue; and sending the executing result of the target instruction to a storage space corresponding to the instruction result storage address based on the mapping relationship. In other words, the instruction result storage address in the sub-storage-space indicates a detailed storage position for storing an instruction result.

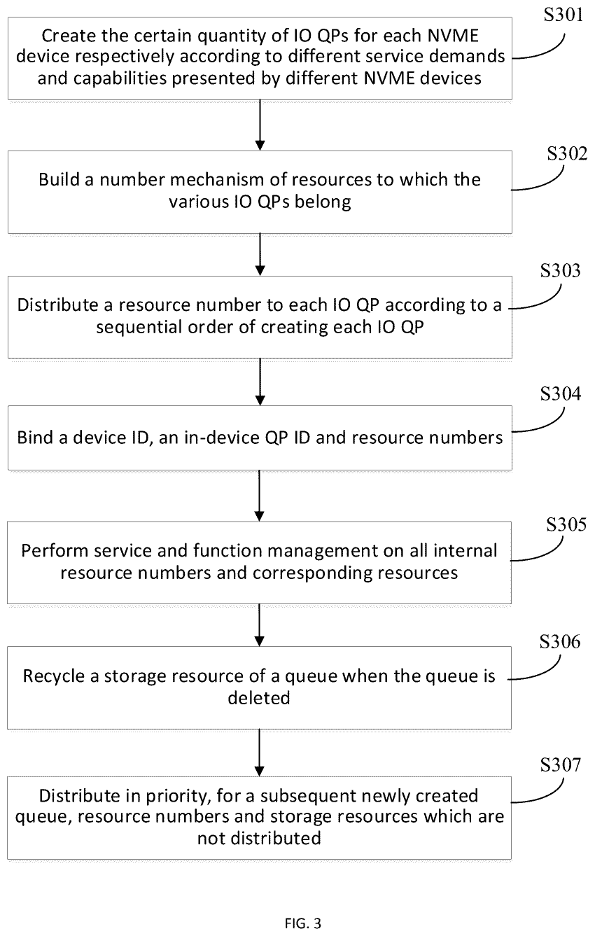

The method for executing the instruction in the embodiment of the present disclosure is described below by taking a system built by the host and the plurality of NVME devices as an application scenario and with reference to flows shown in FIG. 3.

As shown in FIG. 3, the method for executing the instruction includes the following flows.

S301: a certain quantity of input/output QP (IO QP, namely, queues in S110) are established respectively for each NVME device according to different service demands and capabilities presented by different NVME devices. Through the IO QP (may be called a queue QP or QP), data transmission between the NVME devices and the host may be implemented.

Based on the quantity of built IO QP queues, a certain total storage resource is averagely divided into several parts. As each IO QP needs a certain quantity of basic storage resources, a scale of total storage resources may be calculated according to the quantity of IO QP queues, and how many parts of sub-resources it needs to be divided into is related to a capability needed by a current service. For example, some services need more NVME devices, so a total of 1024 IO QPs are needed for completing; and some services need fewer NVME devices, only 128 QPs are needed for completely meeting the service demands.

For another example, a total of 1024 IO QPs are built, so a certain total of storage resources may be divided into a total of 1024 parts of sub-resources. Each part of sub-resource is respectively distributed to an IO QP as a storage resource needed by the IO QP.

The IO QP storage resource is used for storing: base address information of an SQ (corresponding to the above instruction acquisition address), queue depth information of the SQ, doorbell information of the SQ (SQ Doorbell), base address information of a CQ (corresponding to the above instruction result storage address), queue depth information the CQ, doorbell information of the CQ, and interrupt vector information of the CQ, and the like. Detailed functions of these information may refer to descriptions in the related art, which is not limited by the present disclosure.

S302: a number mechanism of resources to which the various IO QPs belong (may also be called a QP storage resource) is built. For example, 1024 parts of resources to which the IO QPs belong are subjected to numbering management and are numbered as 0 to 1023, and each number may correspond to a part of resource to which the IO QP belongs.

Through the above number mechanism, when one NVME device has a plurality of IO QP queues, the NVME device may correspond to each IO QP and a resource number to which the IO QP belongs.

S303: a resource number is distributed to each IO QP according to a sequential order of creating each IO QP, and IO QP information data (for example, information of a device to which the QP belongs, and the like) when each IO QP is created is stored.

S304: each NVME device is numbered as corresponding to a device ID (identity), for each IO QP of the NVME device, there is a corresponding QP ID in an NVME protocol, a device ID plus an in-device QP ID (device ID+in-device QP ID) may be used as its unique identity, then it may be bound to a storage resource number capable of being distributed, and thus different IO QPs of the various NVME devices share an entire storage resource.

The embodiment of the present disclosure provides a resource number distribution management mechanism, the existing limited storage resource is divided and reasonably numbered, each independent queue corresponds to one part of storage resource with a number, and the queue completes some services and functions of the corresponding NVME device based on this part of resource. For a certain independent NVME device, a plurality of queues may be created, so a plurality of parts of storage resources with different numbers may be correspondingly distributed to the NVME device.

S305: service and function management is performed on all internal storage resource numbers and corresponding resources, and interaction of storage commands and data between the host and each NVME device is controlled and implemented by using mutual mapping between the storage resource numbers and device ID plus QP ID (device ID+QP ID).

Through a policy of binding the device ID, the queue ID and the storage resource numbers, the queues may be bound to and mutually mapped to the storage resource numbers, so that during interaction of the NVME device and the host, various detailed parameters of an actual device and an actual queue may be accurately and quickly found, and storage interaction of instructions and data with the host is completed.

S306: for any IO QP of all NVME devices, when the IO QP is deleted, a storage resource number corresponding to the IO QP is recycled, and the number may be stored in a hardware cache.

During an implementation process, when distribution of all the 1024 storage resource numbers in the above example is completed and some IO QPs need to be deleted, some resource numbers and storage resources are recycled, and then redistribution of the resource numbers may be performed. When distribution of the resource numbers is not completed and some IO QPs are already deleted, these recycled resource numbers may be stored firstly, and all data information of the storage resources corresponding to the numbers is removed.

S307: for a subsequent newly created IO QP, resource numbers and storage resources which are not distributed may be distributed in priority. When distribution of all the 1024 resource numbers in the above example is completed, recycled resource numbers stored in the cache may be redistributed to the newly created IO QP in a recycling sequential order.

Through the above resource recycling distribution mechanism, deleted queue numbers and resources thereof in the NVME device are recycled and then may be distributed to the subsequent newly created queue, so as to achieve the purpose of recycling the resources.

It may be known from the above description that the embodiment of the present disclosure provides a queue storage resource dynamic sharing flow under a plurality of NVME devices, and by building a mechanism of resource number distribution management and resource recycling distribution as well as the policy of binding the device ID, the device queue ID and the resource number, the IO QP in the virtual device may be effectively managed under the limited storage resource, and thus the storage services and functions may be flexibly implemented.

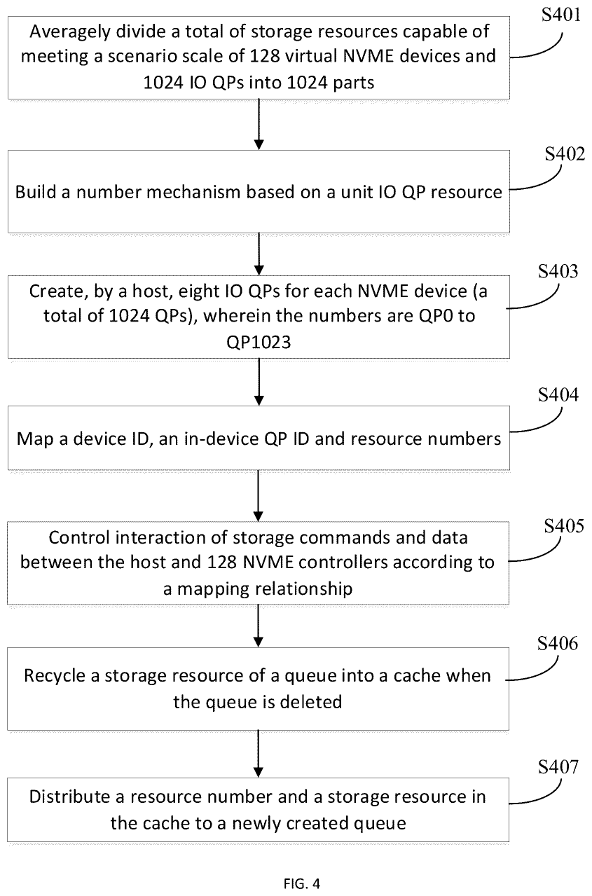

Based on the flows shown in FIG. 3 above, exemplary flows of a detailed application scenario is given below with reference to FIG. 4, the application scenario is a scenario of implementing interaction of storage commands and data of 128 virtual NVME devices and 1024 IO QPs under the demands of the plurality of NVME devices.

Referring to FIG. 4, the method for executing the instruction includes the following flows.

S401: a total of storage resources capable of meeting a scenario scale of 128 virtual NVME devices and 1024 IO QPs are averagely divided into 1024 parts based on the quantity of resources needed by each IO QP.

S402: a number mechanism based on a unit IO QP storage resource (namely, a resource to which the IO QP belongs) is built. 1024 parts of resources to which the IO QPs belong are subjected to numbering management and are numbered as 0 to 1023, and each number corresponds to a part of IO QP storage resource.

S403: the host creates eight IO QPs for each NVME device (a total of 1024 QPs) according to IO capabilities presented by 128 virtual NVME devices, and the numbers are numbered as QP0 to QP1023 in a creating order.

In the present example, for convenience of the description, the quantity of IO QPs of each NVME device is average set. During actual operation, different quantities of IO QPs may also be created for different NVME devices based on service capability and demand of each NVME device so as to meet different service demands. The present disclosure does not limit this.

S404: 128 NVME devices are numbered, the device ID is 0 to 127, for each IO QP of the NVME device, there is a corresponding QP ID in an NVME protocol, the QP ID is set as 0 to 7, so each IO QP may correspond to a resource number, for example, QP3 of the device 5 may be mapped to a resource number 32.

In some embodiments, a mapping table of the correspondence among the resource numbers, the device ID and the QP ID may be built.

S405: interaction of storage commands and data between the host and the 128 NVME devices is controlled and implemented according to mutual mapping between the resource numbers 0 to 1023 and the device ID+QP ID. A detailed implementation is: a mapping table is searched according to the device ID (0 to 127)+QP ID (0 to 7) to which a current instruction belongs, a corresponding resource number is searched out, storage resource information corresponding to the corresponding QP ID in the resource number is acquired, and the storage resource information includes: base address information of an SQ, queue depth information of the SQ, doorbell information of the SQ, base address information of a CQ, queue depth information of the CQ, doorbell information of the CQ, interrupt vector information of the CQ, and the like.

For example, when IO QP 3 of the device 5 in 128 NVME devices receives SQ Doorbell sent by the host, a corresponding resource number 32 may be searched out from the mapping table according to the device ID and the queue ID “5+3” number, then the SQ base address information corresponding to the resource number 32 is read out, an SQ Entry command of the QP 3 of the device 5 is read back to a user side from the host according to the SQ base address information, and subsequent operations such as SQ Entry command parsing execution and storage data transfer are completed.

S406: for any IO QP in 1024 IO QPs corresponding to the 128 NVME devices, when an IO QP is deleted, a corresponding resource number is recycled and may be stored in a hardware cache. For example, if IO QP6 of the device 3 is to be deleted and a resource number corresponding thereto is 10, the number 10 is stored in a first input first output (FIFO) cache.

S407: when distribution of all the 1024 resource numbers is completed, if a new IO QP is intended to be created, the number 10 put first in the FIFO cache may be read out and redistributed.

The embodiment of the present disclosure implements the queue storage resource dynamic sharing flow under the plurality of NVME devices by building the resource number distribution management and recycling distribution mechanism as well as the policy of binding the device ID, the queue ID and the resource numbers. In the meantime, the embodiment of the present disclosure may implement more NVME virtual devices with the limited storage resource, flexible distribution of queue resources in each NVME device may also cause an NVME storage system to support more storage services, the flexibility of the storage system is better improved, the NVME devices with different IO capabilities may be flexibly supported, and creation, working and death of all the devices are flexibly managed.

Based on the similar inventive concept, an embodiment of the present disclosure further provides a system for executing an instruction. The system includes: a server and at least one virtual device (corresponding to the above NVME device), and the at least one virtual device includes an apparatus for executing an instruction. During actual operation, the apparatus for executing the instruction may be arranged inside the virtual device or outside the virtual device.

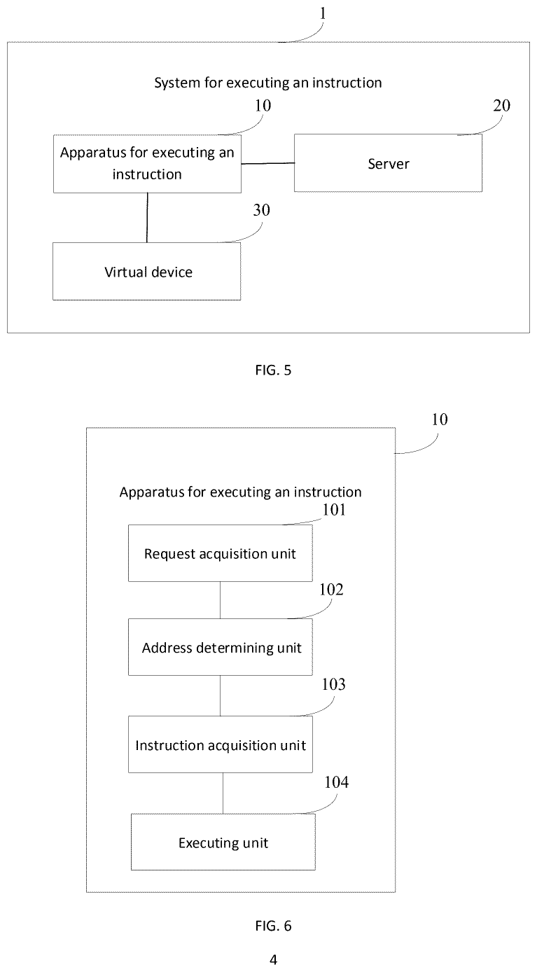

FIG. 5 is a structural block diagram of the system. As shown in FIG. 5, the system 1 shows: the apparatus 10 for executing the instruction, the server 20 and the virtual device 30 (one virtual device is shown in FIG. 5). In this figure, the apparatus for executing the instruction is arranged outside the virtual device.

In some embodiments, for implementing various storage services, there may be a plurality of virtual devices, and each virtual device corresponds respectively to at least one queue.

FIG. 6 is a structural block diagram of an apparatus 10 for executing an instruction according to some embodiments. As shown in FIG. 6, the apparatus 10 for executing the instruction includes: a request acquisition unit 101, an address determining unit 102, an instruction acquisition unit 103 and an executing unit 104.

The request acquisition unit 101 is configured to acquire an instruction acquisition request in a target queue, the instruction acquisition request being used for instructing to acquire a target instruction.

The address determining unit 102 is configured to, based on the instruction acquisition request, determine an instruction acquisition address corresponding to the target queue according to a preset mapping relationship, the mapping relationship indicating a correspondence between information of a queue where the target queue is located and the instruction acquisition address.

The instruction acquisition unit 103 is configured to acquire the target instruction according to the instruction acquisition address.

The executing unit 104 is configured to execute an operation corresponding to the target instruction according to the target instruction.

In the embodiment of the present disclosure, after the request acquisition unit 101 acquires the instruction acquisition request of the target queue, the address determining unit 102 determines the instruction acquisition address corresponding to the target queue according to the mapping relationship, the instruction acquisition unit 103 acquires the target instruction according to the instruction acquisition address, and then the executing unit 104 executes the target instruction. In this way, through the preset mapping relationship, queues and resources to which the queues belong may be managed effectively, effective management of the virtual devices under a limited storage resource is implemented, a storage service instruction may be better executed, and demands of various storage services are met.

In some embodiments, the above apparatus further includes: a queue building unit, a storage space dividing unit and a distribution unit.

The queue building unit is configured to build at least one queue according to a service demand.

The storage space dividing unit is configured to divide a storage space into at least one sub-storage-space which has the same quantity as the quantity of at least one queue.

The distribution unit is configured to respectively distribute each sub-storage-space to a corresponding queue. The sub-storage-space is at least configured to store the instruction acquisition address and an instruction result storage address.

In some embodiments, the above apparatus further includes: a mapping relationship setting unit. The mapping relationship setting unit includes: a correspondence acquisition module and a mapping relationship setting module.

The correspondence acquisition module is configured to acquire a correspondence between information of a queue and information of the sub-storage-space.

The mapping relationship setting module is configured to set the mapping relationship according to the acquired correspondence.

In an embodiment, the above apparatus further includes: an executing result sending unit. The executing result sending unit is configured to send an executing result of the above target instruction to a position corresponding to the instruction result storage address in the sub-storage-space.

In some embodiments, the above apparatus further includes: a storage space releasing unit. The storage space releasing unit is configured to release a sub-storage-space of a queue in response to the queue being deleted.

The apparatus 10 for executing the instruction in the embodiment of the present disclosure may be an apparatus with an operating system. The operating system may be an Android operating system, or an ios operating system, or another possible operating system. The embodiment of the present disclosure does not make a specific limitation.

The apparatus 10 for executing the instruction provided by the embodiment of the present disclosure can implement each process implemented in the method embodiment in FIG. 1, FIG. 3 and FIG. 4, and achieve the same technical effect, which is not described in detail for avoiding repetitions.

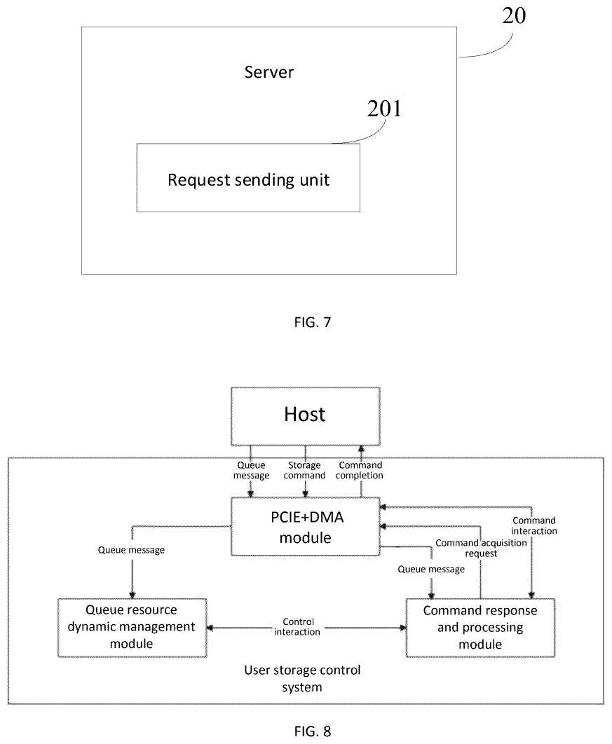

FIG. 7 is a structural block diagram of the above server 20. As shown in FIG. 7, the server 20 includes: a request sending unit 201, configured to send an instruction acquisition request to a target queue of a virtual device, the instruction acquisition request being used for instructing to acquire a target instruction so that the virtual device acquires the target instruction based on a preset mapping relationship, the mapping relationship indicating a correspondence between information of a queue where the target queue is located and an instruction acquisition address.

In an embodiment, the above mapping relationship further indicates a correspondence between the information of the queue where the target queue is located and an instruction result storage address, and the server further includes: an executing result receiving unit and an executing result sending unit.

The executing result receiving unit is configured to receive an executing result of the target instruction from the target queue.

The executing result sending unit is configured to send the executing result of the target instruction to a storage space corresponding to the instruction result storage address based on the mapping relationship.

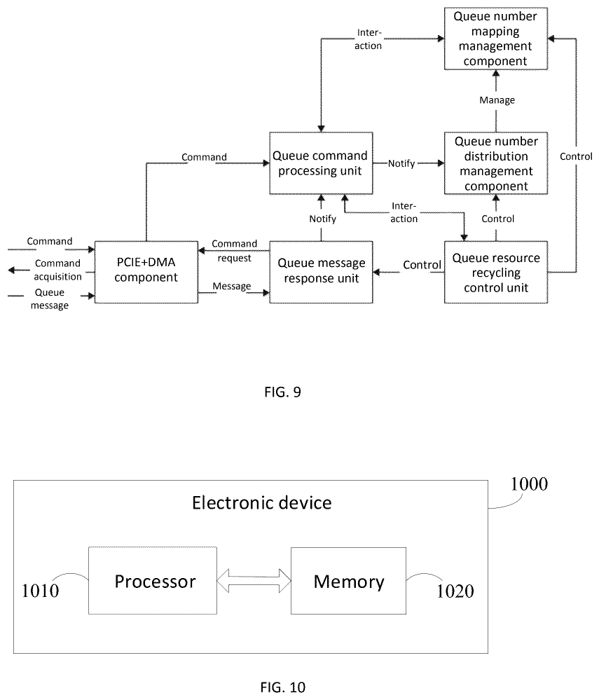

During actual operation, a controller of each NVME device is independently stored under a scenario of a plurality of NVME devices. Namely, each NVME device needs to occupy an independent and complete storage resource to implement interaction of a storage flow between the NVME device and the host. A detailed flow includes: NVME device initialization, an NVME ADMIN flow, an NVME IO flow, and the like. A working principle of a system for executing an instruction in the embodiment of the present disclosure is described below in detail with reference to FIG. 8 and FIG. 9.

FIG. 8 is a diagram of a working principle of the system for executing the instruction according to some embodiments. As shown in FIG. 8, the exemplary system includes: the host and a user storage control system. The host has a function of the above server 20, and the user storage control system has a function of the above apparatus 10 for executing the instruction. The user storage control system includes: a command response and processing module and a queue resource dynamic management module.

Referring to FIG. 8, the working principle of the exemplary system includes: NVME ADMIN flows of steps 1 to 3 and NVME IO flows of steps 4 to 6, and the steps are described as follows.

Step 1: the host sends a message of an ADMIN (administration) queue, namely, ADMIN doorbell (Doorbell), and enters the command response and processing module in the user storage control system through a PCIE and DMA (PCIE+DMA (direct memory access)) module.

Step 2: the command response and processing module receives the ADMIN doorbell, and the ADMIN doorbell may be construed as an ADMIN command acquisition request. The command response and processing module sends an ADMIN command acquisition request of a corresponding queue to the PCIE+DMA module, and the PCIE+DMA module withdraws ADMIN command data from the host.

Step 3: a withdrawn ADMIN command enters the command response and processing module to be parsed by the command response and processing module, and a queue resource dynamic management module is notified of performing QP hardware resource numbering, distribution, recycling and other dynamic managements.

Step 4: the host sends a message of an IO QP queue, namely, IO doorbell (Doorbell), and the message enters the command response and processing module in the user storage control system through the PCIE+DMA module.

Step 5: the command response and processing module sends an IO command acquisition request of the corresponding queue to the PCIE+DMA module, and the PCIE+DMA module withdraws IO command data from the host.

Step 6: the withdrawn IO command enters the command response and processing module, the command response and processing module interacts with the queue resource dynamic management module, mapping between QP resource numbers and device ID+device QP ID is implemented, and thus storage IO command interaction between the user storage control system and the host is implemented.

In the above steps, in an NVME protocol, an ADMIN command is mainly used for presenting of a capability of the NVME device for the host, creation of the NVME device queue, and the like; and the IO command is mainly used for implementing a storage data reading and writing function between the host and the NVME device, and the like.

FIG. 9 is schematic diagram of a working principle of a user storage control system shown in FIG. 8. Referring to FIG. 9, the command response and processing module in FIG. 8 corresponds to: a queue command processing unit and a queue message response unit. The queue resource dynamic management in FIG. 8 corresponds to: a queue number mapping management component, a queue number distribution management component and a queue resource recycling control unit, and a working principle between all parts is described below.

Step 1: the host initializes each NVME controller (having functions of the above command response and processing module and the queue resource dynamic management module in FIG. 8) in the user storage control system through the PCIE+DMA component (namely, the above PCIE+DMA module), and builds a plurality of QPs (namely, IO QPs), including a storage submission queue (SQ) and a storage completion queue (CQ). After the QPs are created, a Doorbell corresponding to each QP is sent to each NVME controller in the user storage control system and enters a queue message response unit of the corresponding NVME controller.

Step 2: when the queue message response unit receives a new queue message, acquisition of a command may be initiated to the host (HOST, not shown in the figure) through the PCIE+DMA component, the command is transferred from HOST back to a queue command processing unit in the controller through the PCIE+DMA component, and meanwhile, the queue number distribution management component is notified.

Step 3: a corresponding QP number is given to each created QP through the queue number distribution management component. For example, if 1024 QPs are created, the corresponding numbers are 0 to 1023, each number corresponds to a unique QP, namely, the unique SQ and CQ; and besides, during creation of the QP, a mapping table and a counter-mapping table between QP resource numbers and the device ID+device QP ID are created in the queue number mapping management component at the same time.

During implementation, a corresponding queue execution flag bit register may be designed for each QP, and when the QP is in a command executing state, a corresponding flag bit may be set as 1.

Step 4: the queue command processing unit performs QP information resource caching and searching on a detailed command according to the queue execution flag bit resister of the QP and the mapping table and the counter-mapping table between the QP resource numbers and the device ID+device QP ID. For example, a base address of each SQ is cached, when acquisition of an IO command (SQ entry) needs to be performed for the host, the base address of the SQ may be withdrawn from an SQ information cache in a corresponding QP resource cache, and thus a corresponding command may be withdrawn from a corresponding address in the host. In the meantime, a base address of each CQ may be cached, when a completion situation (CQ entry) of the command needs to be sent to the host, the base address of the CQ is withdrawn from a CQ information cache in the corresponding QP resource cache, and the CQ entry may be sent to an address corresponding to the host.

Step 5: when the queue command processing unit parses an ADMIN command of deleting a QP, the queue command processing unit notifies the queue resource recycling control unit of performing cleaning and zero clearing processing on all storage resources of the QP, and this part of resource is recycled for subsequent reusing.

The embodiment of the present disclosure adopts a mechanism of recycling QP storage resources, which is implemented by the queue resource recycling control unit, and the unit performs number recycling and caching and stores the number in a cache. For example, when distribution of all the 1024 numbers is completed by the queue number distribution management component, if another new QP is created, the number is withdrawn from the number recycling cache, the number and a corresponding resource are distributed to the newly created QP, and thus the newly created QP can perform normal storage service and function.

In some embodiments, as shown in FIG. 10, an embodiment of the present disclosure further provides an electronic device 1000. The electronic device 1000 includes a processor 1010 and a memory 1020, a program or an instruction capable of running on the processor 1010 is stored on the memory 1020, for example, when the electronic device 1000 is a terminal, the program or the instruction, when executed by the processor 1010, implements all processes of the embodiment of the method for executing the instruction, which can achieve the same technical effect. A detailed description is omitted here for avoiding repetitions.

An embodiment of the present disclosure further provides a readable storage medium. A program or an instruction is stored on the readable storage medium, and the program or the instruction, when executed by a processor, implements all processes of the embodiment of the method for executing the instruction, which can achieve the same technical effect, and a detailed description is omitted here for avoiding repetitions.

The processor is a processor in the electronic device in the above embodiment. The readable storage medium includes a computer-readable storage medium, for example, a computer read-only memory (ROM), a random access memory (RAM), a diskette, an optical disc or the like. The readable storage medium includes a non-transitory computer-readable storage medium.

An embodiment of the present disclosure further provides a chip, and the chip includes a processor and a communication interface. The communication interface is coupled to the processor, the processor is configured to run a program or an instruction so as to implement all processes of the embodiment of the method for executing the instruction, which can achieve the same technical effect, and a detailed description is omitted here for avoiding repetitions.

Further, an embodiment of the present disclosure further provides a computer program product, the computer program product includes a processor, a memory and a program or an instruction which is stored on the memory and capable of running on the processor, and the program or the instruction, when executed by the processor, implements all processes of the embodiment of the method for executing the instruction, which can achieve the same technical effect, and a detailed description is omitted here for avoiding repetitions.

It needs to be noted that a term “comprise”, “include” or any other variant thereof herein intends to cover a non-exclusive inclusion, so that a process, method, a product or an apparatus including a series of elements includes not only those elements, but also includes other elements not listed clearly or further includes inherent elements of this process, method, product or apparatus. Without more limitations, an element defined by the sentence “including one” does not exclude that there are still other same elements in the process, method, product, or apparatus including the element. In addition, it should be pointed out that the range of the method and apparatus in the implementation of the present disclosure is not limited to execution of functions in order shown or discussed, and can further include execution of functions involved in a substantially simultaneous manner or in a reverse order. For example, the described method can be executed in order different from that described, and various steps can be added, omitted, or combined. Moreover, features described with reference to some examples may be combined in other examples.

According to the descriptions in the foregoing implementations, those skilled in the art may clearly learn that the method according to the foregoing embodiment may be implemented by relying on software and a necessary general-purpose hardware platform or certainly by using hardware, but in most of cases, the former is the better implementation. Based on such an understanding, the technical solutions of the present disclosure essentially, or a part contributing to the prior art, may be presented in a form of a computer software product. The computer software product is stored in a storage medium (for example, an ROM, an RAM, a diskette, or an optical disc), which includes several instructions to enable a terminal (which may be a mobile phone, a computer, a server, a network device, or the like) to perform the methods described in the embodiments of the present disclosure.

The embodiments of the present disclosure are described above with reference to the accompanying drawings, but the present disclosure is not limited to the above specific implementations. The above specific implementations are merely illustrative rather than restrictive. Inspired by the present disclosure, those of ordinary skill in the art may still make multiple forms without departing from the essence of the present disclosure and the scope of protection of the claims, which all fall within the protection of the present disclosure.

1. A method for executing an instruction, wherein the method is applied to a virtual device, and comprises:
acquiring an instruction acquisition request in a target queue, the instruction acquisition request being used for instructing to acquire a target instruction;
determining, based on the instruction acquisition request, an instruction acquisition address corresponding to the target queue according to a preset mapping relationship, the mapping relationship indicating a correspondence between information of a queue where the target queue is located and the instruction acquisition address;
acquiring the target instruction according to the instruction acquisition address; and
executing an operation corresponding to the target instruction according to the target instruction.

2. The method according to claim 1, wherein before acquiring an instruction acquisition request in a target queue, the method further comprises:
building one or a plurality of queues according to a service demand;
dividing a storage space into one or a plurality of sub-storage-spaces which have the same quantity as the quantity of the one or plurality of queues; and
respectively distributing each sub-storage-space to a corresponding queue, wherein the sub-storage-space is at least configured to store an instruction acquisition address and an instruction result storage address.

3. The method according to claim 2, wherein the mapping relationship is set in the following manner:
acquiring a correspondence between information of a queue and information of a sub-storage-space thereof; and
setting the mapping relationship according to the acquired correspondence.

4. The method according to claim 2, wherein after respectively distributing each sub-storage-space to a corresponding queue, the method further comprises:
releasing a sub-storage-space of a queue in response to the queue being deleted.

5. The method according to claim 2, wherein after executing an operation corresponding to the target instruction according to the target instruction, the method further comprises:
sending an executing result of the target instruction to a storage space corresponding to the instruction result storage address.

6. A method for executing an instruction, wherein the method is applied to a server, and comprises:
sending an instruction acquisition request to a target queue of a virtual device, the instruction acquisition request being used for instructing to acquire a target instruction so that the virtual device acquires the target instruction based on a preset mapping relationship, and the mapping relationship indicating a correspondence between information of a queue where the target queue is located and an instruction acquisition address.

7. The method according to claim 6, wherein the mapping relationship further indicates a correspondence between information of a queue where the target queue is located and an instruction result storage address, and the method further comprises:
receiving an executing result of the target instruction from the target queue; and
sending the executing result of the target instruction to a storage space corresponding to the instruction result storage address based on the mapping relationship.

8. An apparatus for executing an instruction, comprising:
a request acquisition unit, configured to acquire an instruction acquisition request in a target queue, the instruction acquisition request being used for instructing to acquire a target instruction;
an address determining unit, configured to, based on the instruction acquisition request, determine an instruction acquisition address corresponding to the target queue according to a preset mapping relationship, the mapping relationship indicating a correspondence between information of a queue where the target queue is located and the instruction acquisition address;
an instruction acquisition unit, configured to acquire the target instruction according to the instruction acquisition address; and
an instruction executing unit, configured to execute an operation corresponding to the target instruction according to the target instruction.

9. The apparatus according to claim 8, further comprising:
a queue building unit, configured to build at least one queue according to a service demand;
a storage space dividing unit, configured to divide a storage space into at least one sub-storage-space which has the same quantity as the quantity of at least one queue; and
a distribution unit, configured to respectively distribute each sub-storage-space to a corresponding queue, wherein the sub-storage-space is at least configured to store the instruction acquisition address and an instruction result storage address.

10. The apparatus according to claim 9, wherein the apparatus further comprises: a mapping relationship setting unit, and
the mapping relationship setting unit comprises:
a correspondence acquisition module, configured to acquire a correspondence between information of a queue and information of a sub-storage-space thereof; and
a mapping relationship setting module, configured to set a mapping relationship according to the acquired correspondence.

11. A server, comprising:
a request sending unit, configured to send an instruction acquisition request to a target queue of a virtual device, the instruction acquisition request being used for instructing to acquire a target instruction so that the virtual device acquires the target instruction based on a preset mapping relationship, and the mapping relationship indicating a correspondence between information of a queue where the target queue is located and an instruction acquisition address.

12. The server according to claim 11, wherein the mapping relationship further indicates a correspondence between the information of the queue where the target queue is located and an instruction result storage address, and the server further comprises:
an executing result receiving unit, configured to receive an executing result of the target instruction from the target queue; and
an executing result sending unit, configured to send the executing result of the target instruction to a storage space corresponding to the instruction result storage address based on the mapping relationship.

13. A system for executing an instruction, comprising: the server according to claim 11 and at least one virtual device, wherein the at least one virtual device comprises the apparatus for executing the instruction according to claim 8.

14. An electronic device, comprising a processor and a memory, wherein the memory stores a program or an instruction capable of being run on the processor, and the program or the instruction, when run by the processor, performs the method according to claim 1.

15. A non-transitory readable storage medium, having a program or an instruction stored thereon, wherein the program or the instruction, when run by a processor, performs the method according to claim 1.

16. An electronic device, comprising a processor and a memory, wherein the memory stores a program or an instruction capable of being run on the processor, and the program or the instruction, when run by the processor, performs the method according to claim 6.

17. A non-transitory readable storage medium, having a program or an instruction stored thereon, wherein the program or the instruction, when run by a processor, performs the method according to claim 6.
